(19) United States
(12) Patent Application Publication
(10) Pub. No.: US 2021/0123296 A1
(43) Pub. Date: Apr. 29, 2021

(54) VIEWING APPARATUS COMPRISING A SWITCHABLE PANE

(71) Applicant: VISTAMATIC LIMITED, Hainault, Essex (GB)

(72) Inventor: Tim GRIGSBY, Essex (GB)

(21) Appl. No.: 16/633,505

(22) PCT Filed: Jul. 26, 2017
(86) PCT No.: PCT/GB2017/052180

§ 371 Date: Jan. 23, 2020

(51) Int. Cl. E06B 3/67; E06B 9/24; G02F 1/163

(52) U.S. Cl. CPC E06B 3/6722; E06B 2009/2464; G02F 1/163; E06B 9/24

(57) ABSTRACT

A viewing apparatus comprises a switchable pane electrically alterable between an unclear optical state and a clear optical state, and a power supply circuit connected to the switchable pane and arranged to draw power from a battery to alter the optical state of the switchable pane. The power supply circuit may comprise a switched-mode power supply arranged to supply an AC voltage to the switchable pane. The viewing apparatus may comprise a primary unit, in which at least one of the power supply circuit and the switchable pane is housed, and a portable module accommodating the battery from which the power supply circuit is arranged to draw power. The apparatus may be arranged for releasable electrical connection between the primary unit and the portable module so that the optical state of the switchable pane is user alterable by placing the portable module into electrical connection with the primary unit and by withdrawing the portable module from electrical connection with the primary unit.

### TECHNICAL FIELD OF THE INVENTION

The present invention relates to a switchable glass panel, and to a power supply arrangement for such a viewing panel.

### BACKGROUND OF THE INVENTION

Switchable glass, also known as smart glass, has light transmission properties that are alterable, commonly by applying a voltage. For example, glazing that incorporates a solid-state polymer dispersed liquid crystal (PDLC) material typically diffuses light, having a milky or frosted appearance, and becomes more transparent when a voltage is applied to the switchable material. PDLC-based switchable glass is often used to provide privacy.

PDLC switchable glass products are typically designed for use with an AC power supply, since a DC voltage can progressively polarise the liquid crystal microstructure and thus permanently degrade the electrically switchable material. In certain applications, such as in switchable glass door panels where external wiring could present a hazard or vulnerability, it may be desirable to conceal or minimise external wiring from the mains power supply.

This may be of particular value in institutions such as schools, hospitals and prisons, where electrical and architectural fittings may be exposed to misuse or vandalism. Moreover, in such establishments, it may be desirable to prevent unauthorised use of the switchable glass to ensure that an appropriate level of privacy can be maintained.

Objects of the invention include the provision of a switchable glass unit that addresses the aforementioned issues, that has a self-contained power supply, is configurable to prevent unauthorised use, is arranged to record usage, and/or consumes minimal power. Further objects of the invention include the provision of a system for authorising and/or logging access to such a switchable glass unit by multiple users and/or to multiple switchable glass units.

### SUMMARY OF THE INVENTION

According to the invention, there is provided a viewing apparatus that comprises: a switchable pane electrically alterable between an unclear optical state and a clear optical state; and a power supply circuit connected to the switchable pane and arranged to draw power from a battery to alter the optical state of the switchable pane.

The viewing apparatus may comprise: a primary unit in which at least one of the power supply circuit and the switchable pane is housed; and a portable module accommodating the battery from which the power supply circuit is arranged to draw power, wherein the apparatus is arranged for releasable electrical connection between the primary unit and the portable module so that the optical state of the switchable pane is user alterable by placing the portable module into electrical connection with the primary unit and by withdrawing the portable module from electrical connection with the primary unit. The portable module may be sized and configured for handheld use. Electrical contacts may be externally accessible on the primary unit for electrical connection between the primary unit and the portable module. The power supply circuit may be arranged to supply power to the switchable pane when the portable module is in electrical connection with the primary unit, and may be arranged to supply no power to the switchable pane when the portable module is not in electrical connection with the primary unit. It may be arranged to maintain the switchable pane in its unclear optical state unless the portable module is in electrical connection with the primary unit, and may be arranged to maintain the switchable pane in its clear optical state until the portable module is withdrawn from electrical connection with the primary unit.

The apparatus may comprise an access controller arranged to receive authentication data and to selectively allow or prevent the supply of power to the switchable pane according to the data received. The apparatus may comprise a register in the primary unit from which data is readable by the access controller, and may comprise a code generator in the primary unit from which a code is receivable by the access controller. The apparatus may comprise a register in the portable unit from which data is readable by the access controller, and may comprise a code generator in the portable unit from which a code is receivable by the access controller. The access controller may be arranged to selectively allow or prevent the supply of power to the switchable pane according to a combination of the data received from the external register and data received from a register in the primary unit. The access controller may be arranged to receive data via electrical contacts that are externally accessible on the primary unit. It may be comprised in the primary unit or the portable module, may be powered by a battery in the portable module, and may be arranged to be inoperable by a user unless the portable module is in electrical connection with the primary unit.

The apparatus may comprise an access recorder arranged to log usage or attempted usage of the primary unit, such as interaction between the primary unit and the portable module. The apparatus may comprise a register in the primary unit from which authentication data is readable by the access recorder, and may comprise a register external to the primary unit from which authentication data is readable by the access recorder, such as comprised in the portable module.

One or each of the primary unit and the portable module may comprise a data connection, may be configured to provide logged usage data to a computer via the data connection, and may be configured to receive authentication data from a computer via the data connection. Where the portable module has a data connection, a docking station may be arranged to receive the portable module, to receive logged usage data from the portable module via the data connection and provide the logged data to a computer, to provide authentication data received from a computer to the portable module via the data connection, and/or to recharge a battery accommodated in the portable module.

The apparatus may comprise a management system operable by a user, such as via a user interface of a computer, to manage the authentication data to selectively allow or prevent operation of the primary unit by the portable module, and/or to display or report the logged usage data. The apparatus may comprise a plurality of the primary units, wherein the management system is user configurable to select which of the primary units are operable by the portable module. The apparatus may comprise a plurality of the portable modules, wherein the management system is user configurable to select by which of the portable modules the, or each, primary unit is operable.

The primary unit may comprise a housing that frames the switchable pane, and may be adjustable to accommodate different thickness switchable panes. The switchable pane may comprise a polymer-dispersed liquid crystal (PDLC) film laminated on a layer of glass or between two layers of glass, and may comprise a sealed glazing unit. The primary unit may comprise a door or part of a door.

The power supply circuit may be arranged to supply an AC voltage to the switchable pane, may comprise a switched-mode power supply, and may comprise two DC-DC converters, such as two flyback converters. The circuit may comprise two capacitors, each connected to receive an output voltage of a respective DC-DC converter, so that the two DC-DC converters are each operable to charge a respective capacitor. Each of the two DC-DC converters may be operable to discharge the capacitor which the other of the two DC-DC converters is operable to charge. The circuit may be arranged to operate the two DC-DC converters in succession, so as to provide an alternating voltage between the two capacitors to drive the switchable pane. The circuit may comprise a controller, which may be arranged to initiate pulse-driven operation of each DC-DC converter in turn, and may be arranged to monitor voltages across each of the two capacitors and to suspend pulse-driven operation of each DC-DC converter when the voltage across the respective capacitor being charged by that DC-DC converter exceeds a predefined threshold.

### DETAILED DESCRIPTION OF THE INVENTION

In order that the invention may be more clearly understood embodiments thereof will now be described, by way of example only, with reference to the accompanying drawings, of which:

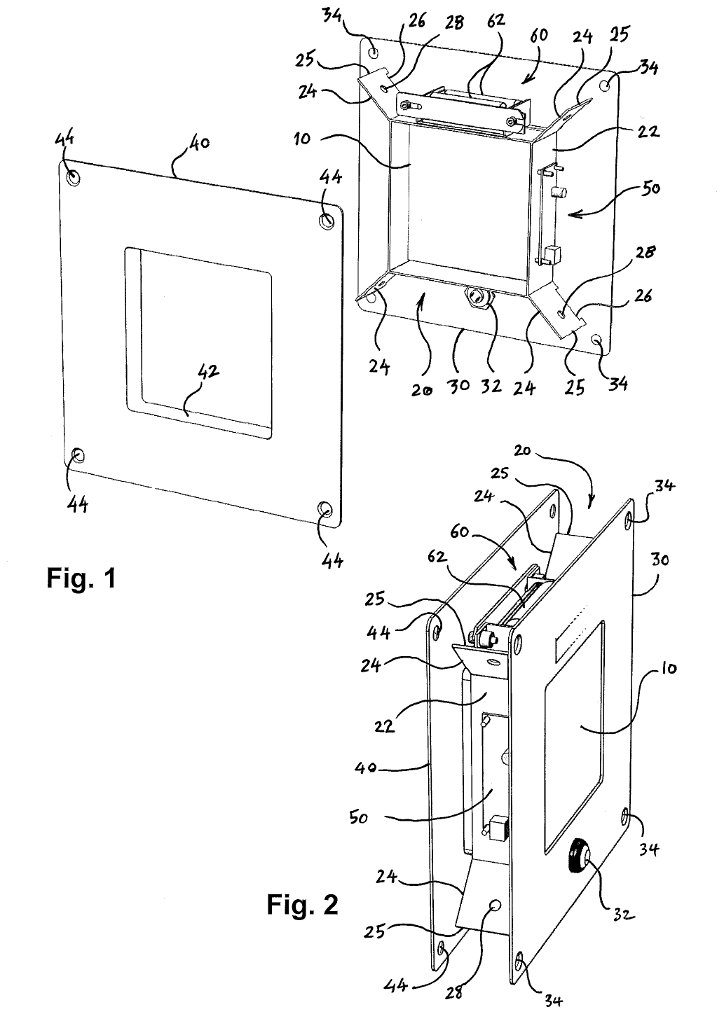

FIG. 1 is a partially exploded perspective view of a switchable glass viewing panel;

FIG. 2 is a perspective view of the viewing panel of FIG. 1;

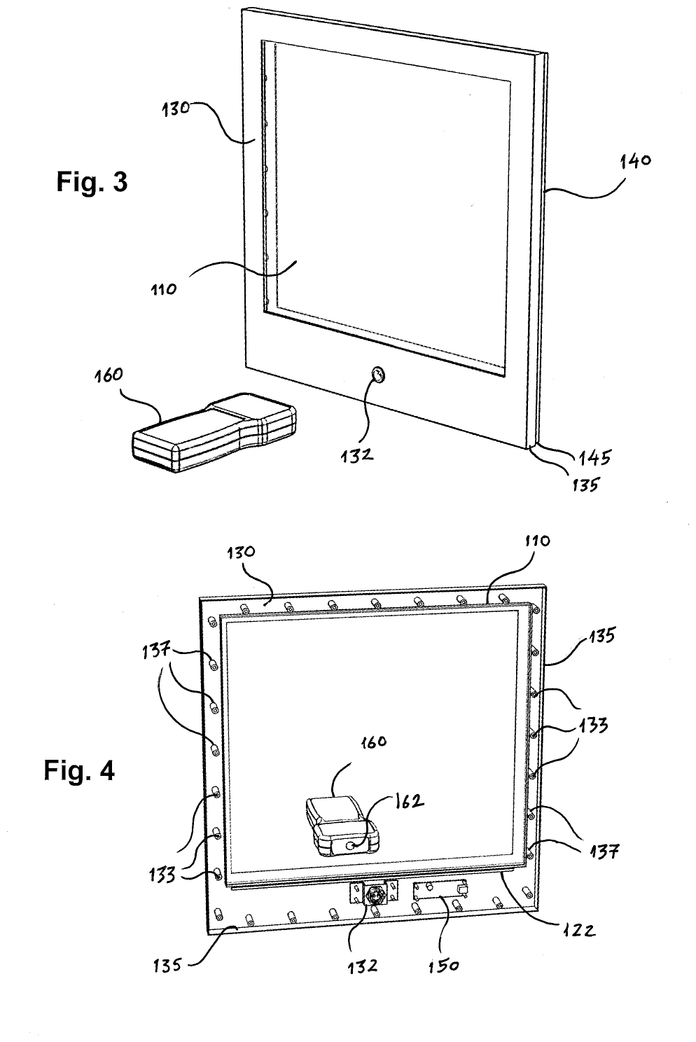

FIG. 3 is a perspective view of another switchable glass viewing panel with a portable power supply;

FIG. 4 is a perspective view of part of the viewing panel of FIG. 3 showing its interior;

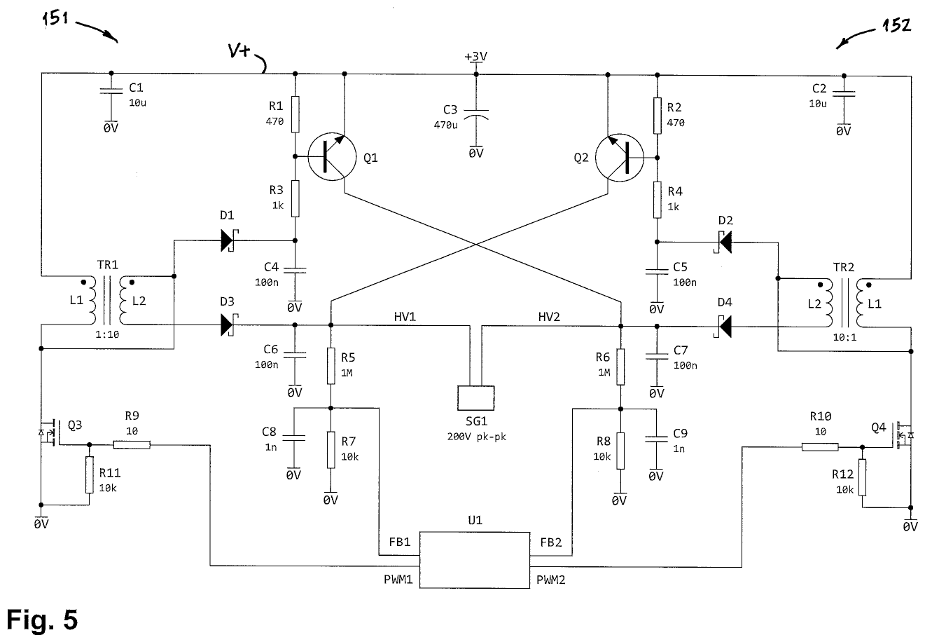

FIG. 5 is a simplified circuit diagram showing part of a power supply circuit for use in the viewing panel(s) of FIG. 1 and/or FIG. 3; and

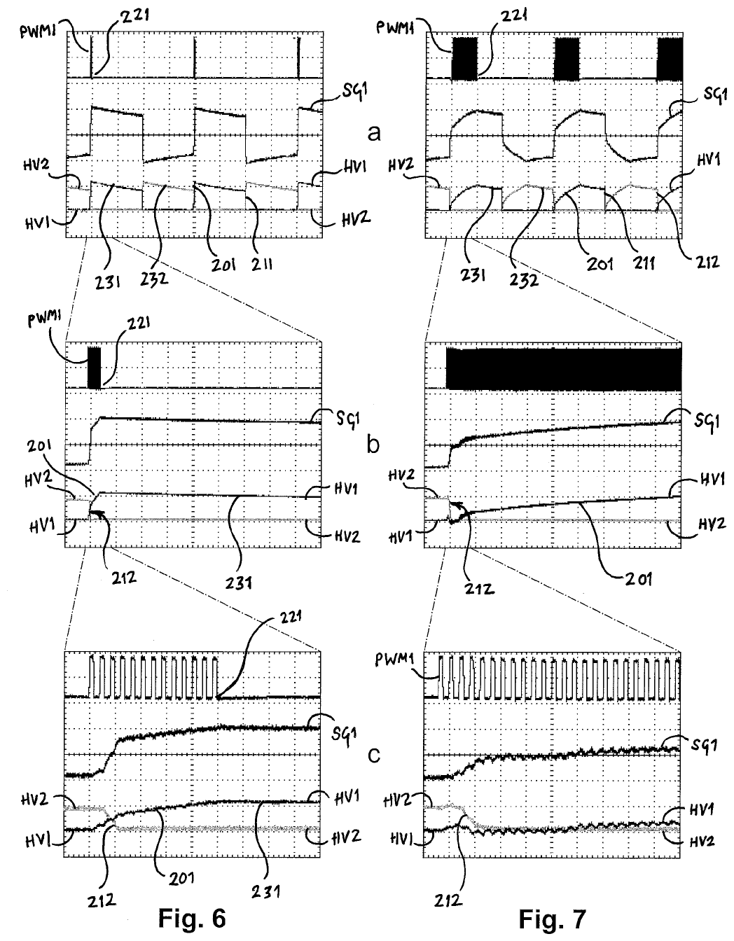

FIGS. 6-7 show representative plots of input and output voltages of the power supply circuit of FIG. 5.

The viewing panel of FIGS. 1 and 2 comprises a switchable glass pane 10 mounted in a support 20 and housed between two outer plates or bezels. Of these, the front plate 30 has a switch 32, such as a monostable pushbutton, for operating the switchable screen, and the rear plate 40 has an inner lip 42 that slidably engages with a square inner frame 22 of the support 20 and overlaps the outer edges of the switchable glass pane 10.

The panel is arranged to be mounted in a door so that the support 20 centres and aligns the switchable glass pane 10 in a substantially square aperture cut into the door, by means of diagonal projections 24 at each corner of the support 20. The outer plates 30,40 are secured to the door by means of countersunk screws for which appropriate holes 34,44 are provided, such as near the outer corners of each plate 30,40. The corner projections 24 are arranged to space the inner frame 22 from the internal surface of the aperture in the door, providing an intervening space in which to accommodate a power supply circuit 50 and a battery module 60 which are secured to the inner frame 22. The corner projections 24 take the form of plates that project diagonally outward from the inner frame 22, each having an outermost edge 25 that runs perpendicular to the plane of the glass 10, to slidably engage the support frame 20 with the corners of an aperture cut through the door, such as with drill holes that have been bored through the door to enable the aperture to be cut with a jig-saw, so that the support 20 is self-aligning in the aperture.

Corner projections 24 are provided with notches 26 and/or holes 28 through which cabling (not shown) may be routed to connect the power supply circuit 50 with the batteries 62, external control switch 32, and switchable glass pane 10. The unit is designed to run from two AAA batteries, which may be replaced by unscrewing the front or rear fascia 30,40 and removing the support frame 20, replacing the batteries, and re-mounting the unit.

Another viewing panel is shown in FIGS. 3 and 4 which is intended for commercial or institutional use, such as in prisons, secure healthcare facilities, and other locations where security and privacy may be of particular concern. In this arrangement, the viewing panel comprises front and rear steel plates 130,140 which form an outer casing that frames the switchable glass pane 110. Each the outer plates 130,140 is pressed or machined so that it has an upstanding peripheral lip 135,145, the respective lips slidably engaging one another so that the casing 130,140 forms a closed unit. The rear plate 140 is provided with holes (not shown) through which screws are inserted into threaded bores 133 in the front plate 130 to secure the front and rear casing plates 130,140 together.

The assembled unit may be incorporated into a door, such as by means of traditional glazing beads, treating the unit as a whole including its outer casing 130,140 as a glazing panel. The unit is preferably framed or embedded in the door so that its external screws and the seam between the peripheral lips 135,145 of the front and rear casings 130,140 are protected and concealed from view.

The switchable glass pane 110 may be a single layer of glass coated with a PDLC material or another material with switchable optical properties, but is preferably formed by laminating the PDLC or other optical material between two layers of glass, so that the pane forms a sealed glazing unit. Although tempered glass is preferred, the switchable pane 110 may comprise other transparent glazing materials such as acrylic or polycarbonate instead of glass. However, for heavy-duty use, the glazing preferably incorporates bulletproof glass, fire-resistant glass, or both.

The switchable glass pane 110 is supported on a ledge 122 and between rows of lugs 137 that comprise the threaded bores 133 for fastening the front and rear plates 130,140 of the casing together, the ledge 122 and the lugs 137 each projecting inwardly from the front plate 130. The relative depths to which the peripheral lips 135,145 and the internal lugs 137 project are selected to accommodate a wide range of thicknesses of switchable glass pane, simply by varying the length of the screws and/or the depth to which each screw is tightened. For example, the outermost peripheral lip 135 preferably projects to a greater depth than the other lip 145 and the lugs 137.

A power supply circuit 150 is mounted inside the front casing 130 to supply an operating voltage to the active optical material of the switchable glass pane 110. However, unlike the viewing panel of FIGS. 1 and 2, the arrangement of FIGS. 4 and 5 lacks an internal battery and does not contain any internal source of power to the circuit. Instead, batteries from which the circuit 150 draws power are located in an external portable battery module 160. The portable battery module 160 and the front casing 130 are provided with pairs of electrical contacts arranged for transmission of power from the battery module 160 to the power circuit 150, such as in the form of a plug 162 on the battery module and a socket 132 in the front casing 130, or vice versa. Alternatively, conforming flush or recessed contacts may be provided. Although a direct plug-in connection or touch contact is preferred, it is also envisaged that an intermediate connector, such as a cable, may be provided for connecting the battery module 160 to the switchable viewing panel.

The absence of a power source within or in permanent connection with the viewing panel itself renders the switchable glass inoperable without the battery module. This is particularly advantageous in environments where the switchable glass should be operable by authorised personnel only. Since the switchable glass retains an opaque or frosted appearance when no voltage is applied, the glazing would remain blanked-out by default, so that only an authorised user may operate the viewing panel to see through the pane. For example, this could allow an authorised healthcare professional to check on a vulnerable patient without allowing other patients or unauthorised members of staff to do so. In the embodiment illustrated, the portable module has the form of a pocket-sized, plug-in handheld unit, although other form factors may be suitable, such as a badge or key fob.

The electrical connection established between the battery module 160 and the power circuit 150 is releasable, so that the battery module can be connected momentarily, to clear the switchable glass 110, and then released again to opacify or obscure the switchable glass. In preferred embodiments there is no self-supporting mechanical engagement between the power module 160 and the viewing panel. For example the electrical contacts or plug and socket 132,162 may be arranged to disconnect, such as under the action of gravity or by means of a spring or other resilient biasing means, unless the power module 160 is held in place by the user.

In certain embodiments, operating the switchable glass requires some form of authentication in addition to the battery itself. For example, a user may be required to enter a correct passcode into a keypad on the battery module or the viewing panel, or to provide biometric data to a reader on either unit. The handheld battery unit 160 may include authentication data stored in a register and readable by a reader in the viewing panel, or vice versa. The authentication preferably requires a reciprocal exchange of data between the handset and the door panel before an operational power supply can be established, and may involve the operation of a code generator in one or both units. The authentication process may be entirely powered by the batteries, so that it is inoperable without them. Any suitable transmission method may be provided, including magnetic, optical, electrical, or near-field radio transmission, for example. In certain embodiments, the authentication data is read via electrical contacts, which may be comprised in the same plug and socket arrangement, or conforming set of contacts, that are used for transmission of power from the battery module 160 to the power supply circuit 150 in the viewing panel. This could involve the use of a combined power and data connector, in the manner of a USB port or equivalent, although it may be preferable that a non-standard type of connector be used and, as discussed above, that any connection formed between the battery and power circuit is not mechanically self-sustaining.

To manage access to multiple viewing panels by multiple users, such as in a large institution or across multiple sites, a central database of access data may be maintained on a computer such as a server. The access data may include user identification data, encryption keys, permissions relating individual users to individual viewing panels, and scheduling information that allows user access to each viewing panel to be set according to a timetable, for example.

In certain embodiments, the battery unit 160 comprises a processor that logs each instance of viewing panel operation, or attempted operation of a viewing panel, maintaining details such as the time, user identity, viewing panel location, access permissions and other authentication data, for example. The battery module communicates with the server, such as via a wireless LAN or other radio transmission means, or via a wired data connection to network access point, desktop computer, or mobile computing device. In a preferred embodiment, the battery module is provided with a dock that is arranged to recharge the battery or batteries in the module and also to establish a data connection, via a connector in the dock, to the server.

By means of such a wired or wireless connection, the logged access data in the handheld unit is communicated to the server for entry into a central database of the usage, or attempted usage, of each viewing panel by each user. The server also transmits authentication data to the handheld unit to replace or update authentication data stored locally on the handheld device. In this manner, the portable module may be connected to a docking station or computer to recharge at the end of a working day or work shift so that, during charging, its logged usage data may be transmitted to the server, and any updated user access/authentication data may be received from the server to be stored locally on the handheld device. The updated user access/authentication data may include changes to individual permissions or encryption data, and may for example be specific to the authorised user's schedule for the following day or to the access permissions of another authorised user who is next scheduled to use the handheld unit. In alternative systems, the communication may be one-way, for example if access permissions are actively managed but logging of usage data is not required, or if usage data is logged but access permissions are not actively managed.

To enable the viewing panels of FIG. 1-2 or 3-4 to operate, it is desirable that the internal or external batteries provide a reliable source of power, since it would be inconvenient to operate either panel if the batteries were too rapidly drained by doing so or if overly large batteries were required to maintain power for a reasonable duration. A power supply circuit 150 to facilitate efficient battery operation of the switchable glass viewing panels has been developed with this in mind.

In this arrangement, the internal or external battery or batteries are connectable to provide a DC supply voltage via an appropriate overvoltage protection and voltage regulation arrangement (not shown). The DC supply voltage V+ powers a microcontroller U1 and a switched power supply controlled by the microcontroller U1, as shown schematically in FIG. 5, which functions as an inverter to provide an AC voltage to the switchable glass pane SG1. Representative voltage input and output traces of the circuit are shown in FIG. 6 for a small switchable glass panel and in FIG. 7 for a large switchable glass panel. The switched power supply circuit 150 is symmetrically arranged, essentially comprising two step-up DC-DC converters 151,152 arranged to operate in sequence, each receiving a pulsed control signal PWM1,PWM2 from the microcontroller U1 and providing a pulsed output HV1,HV2 at much higher voltage than the DC supply voltage V+ from the battery and much lower frequency than the pulsed control signal PWM1,PWM2. For example, the pulsed control signals PWM1,PWM2 may be in the kHz to GHz range and the DC supply voltage V+ may be in the range 1-6V, preferably 3V, whilst the output pulses HV1,HV2 are preferably around 50-60 Hz and may be in the range 40-340V or more preferably 70-170V. Since the DC-DC converters 151,152 are operated in sequence, their output voltages HV1,HV2 are in antiphase so that, when connected across the terminals of the switchable glass pane SG1, they provide an alternating voltage HV1-HV2 with double the peak-to-peak amplitude of the DC-DC converter output pulses HV1,HV2 and at, or close to, an AC mains frequency. This is desirable because commercially available switchable optical materials and switchable glass panes will typically have been tested and rated for use at mains voltages and frequencies, so that the designer is able to select from a wide range of switchable glazing products for use with power supply and outer frame of the viewing panel.

In the DC-DC converter 151 forming the left-hand side of FIG. 5, the microcontroller U1 supplies a pulsed control signal PWM1 that switches a transistor Q3 to drive a pulsed current through the primary coil L1 of a step-up transformer TR1. The turns ratio is selected to generate a much larger alternating voltage in the secondary coil L2 of the transformer TR1, which is directed by a diode D3 to charge a capacitor C6 that is connected, in parallel with a large resistance R5+R7, across the DC output HV1, as indicated by the ascending slope 201 of HV1 in FIGS. 6b and 7b. In this regard, the DC-DC converter 151 has the topology of a flyback converter. The pulsed control signal PWM1 is arranged to operate the flyback converter in continuous mode, so as to maximise the DC output HV1 across the output capacitor C6 in relation to the low-voltage DC supply V+.

Between pulses of the input control signal PWM1, as the transistor Q3 switches abruptly to its off-state, residual current flowing in the primary coil L1 of the transformer TR1 is diverted via another diode D1 to rapidly charge a second capacitor C4. The second capacitor C4 is connected via series resistors R1,R3 to the 3V DC supply voltage V+, and an NPN bipolar transistor Q1 is connected with its base-emitter junction across the DC supply side resistor R1 and its collector at the high-voltage output HV2 of the other DC-DC converter 152 that forms the right-hand side of the circuit shown in FIG. 5. In this arrangement, the second capacitor C4 is maintained at the DC supply voltage V+, and exceeds it when receiving pulsed current from the primary coil L1 of the transformer TR1 via the diode D1. When the voltage across the second capacitor C4 exceeds the DC supply voltage V+ by a trace amount, the transistor Q1 is forward-biased so that it discharges the opposite output capacitor C7, as shown in FIGS. 6 and 7 by the drop 212 in the output voltage HV2 supplied by the right-hand DC-DC converter 152.

The right-hand side of the circuit functions in the same manner, with pulsed control signal PWM2 controlling switch Q4 to drive the transformer TR2 so that the secondary coil L2 charges capacitor C7 via diode D4 in the manner of a flyback converter to provide a higher-voltage DC output HV2, and a further capacitor C5 is charged by residual current in the primary coil L1 of transformer TR2 to forward-bias transistor Q2 so that it discharges the output capacitor C6 of the left-hand flyback converter 151, as shown in FIGS. 6a and 7a by the drop 211 in its output voltage HV1. Thus, by supplying pulsed control signals to the left-hand and right-hand DC-DC converters 151,152 in sequence so that one side is energised at a time, as soon as one side is energised and its capacitors begin to charge, the other side will be immediately de-energised by discharging its output capacitor C6/C7 so that its output voltage HV1,HV2 drops rapidly to the level of the DC supply voltage V+, i.e. 3V.

The microcontroller U1 is configured to start generating the pulsed control signals PWM1,PWM2 at regular intervals defined by the period of the desired AC output frequency, and in antiphase with one another at that frequency. For example, the microcontroller U1 may produce a square wave with a 20 ms period and a 50% duty cycle, with initiation of one control signal PWM1 triggered by the rising edge and initiation of the other control signal PWM2 triggered by the falling edge. Thus, control signals PWM1,PWM2 are initiated to drive alternate DC-DC converters 151,152 at 10 ms intervals.

The microcontroller U1 also monitors each DC output voltage HV1,HV2 via the feedback voltage signal FB1,FB2 from a respective potential divider R5:R7,R6:R8. The microcontroller U1 is configured to stop generating the pulsed control signal PWM1,PWM2 in the event that the corresponding feedback voltage FB1,FB2 exceeds a predefined threshold value (which equates to the corresponding DC output voltage HV1,HV2 exceeding an equivalent threshold). For example, in the arrangement illustrated in FIG. 5, the microcontroller U1 may be programmed to terminate pulse generation when the feedback signal FB1,FB2 exceeds about 1V, indicating that the corresponding DC output voltage HV1,HV2 exceeds about 100V. Focusing again on the left side, once the pulse generation PWM1 stops, the output capacitor C6 sustains the DC output voltage HV1, discharging slowly as energy is dissipated by the active switchable optical material SG1 and the output resistors R5,R7, as illustrated by the termination 221 of the pulsed control signal PWM1 in FIGS. 6 and 7 (PWM2 not shown) and the descending slopes 231,232 of the output voltages HV1,HV2.

In a preferred embodiment, the microcontroller U1 is configured to provide a stable reference voltage of 1.024V that is substantially independent of its DC supply voltage V+, and to operate as a pair of comparators that each provide an output signal indicating whether the stable reference voltage is exceeded by the respective feedback signal FB1,FB2. Thus, the stable reference voltage can provide the threshold for terminating pulse generation, as discussed above, so that control of each DC-DC converter 151,152 is independent of the battery voltage over a normal operating range. This means that the duration of each burst of pulses generated at the start of each half-cycle will compensate for any voltage drift as the battery depletes. Effectively, the duration of each pulsed charging burst, rather than the width of individual pulses within it, is modulated to regulate the peak output voltage.

On that basis, although it is envisaged that the pulsed control signals PWM1,PWM2 may be pulse-width controlled by varying the duty cycle to regulate the feedback signal FB1,FB2 or to compensate for variation in the battery voltage, it is not necessary to use pulse-width modulation because essentially the same outcome is achieved by varying the number of pulses so that charging stops when each output capacitor C6,C7 is charged to the desired voltage. Thus, the pulsed control signals PWM1,PWM2 may be generated by a numerically controlled oscillator operating in fixed duty-cycle (FDC) mode.

In a preferred embodiment, the microcontroller U1 is provided with selective auto-shutdown and auto-restart functionality, so that its high-frequency pulse generators or pulse-width modulators may be suspended to and re-enabled from an inactive state in which they consume little or no power. In this embodiment, auto-shutdown is triggered by either comparator, so that if a feedback signal FB1,FB2 exceeds the threshold value or stable reference voltage, the high-frequency pulse generator or pulse-width modulator is suspended to its power-saving mode. Auto-restart is triggered by detection of rising and falling edges of the 50 Hz pulse, for example, so that the pulse generator or pulse-width modulator is re-enabled at the start of each half-wave of the AC cycle, or each of the two pulse generators is re-enabled in turn at the start of respective alternate half-waves. Suitable microcontrollers for providing the auto-shutdown and auto-restart functionality and the stable reference voltage include members of the PIC16(L)F1503 family of processors supplied by Microchip Technology Inc. of Arizona, USA.

A power supply circuit as described above has been found to consume substantially less power than would be expected from a typical DC-AC inverter, which is highly beneficial for battery powered operation of the panel. For example, in the viewing panel of FIGS. 1 and 2, a pair of AAA batteries is expected to last for around five years, assuming that the product is used ten times per day for ten seconds each time.

In the illustrated embodiments, the power supply circuit 50,150 is housed within a frame of the switchable glass screen. However, it is also envisaged that part of the power circuit 50,150 may be housed in a door separately from the frame of the viewing panel, such as in a separate modular housing and/or embedded within the door. In embodiments that feature a portable power supply module 160, it is also envisaged that part of the power supply circuit 150 may be comprised in the portable module 160 rather than the viewing panel housing or the door. For instance, the portable battery module 160 may comprise substantially all of the power supply circuit 150 so that it produces and supplies the desired AC power output to the switchable screen 110 via the external contacts 132,162. Alternatively, a transformer of each DC-DC converter 151,152 may comprise an inductive link between a primary coil in the portable module 160 and a secondary coil in the viewing panel housing or the door.

The above embodiments are described by way of example only. Many variations are possible without departing from the scope of the invention as defined in the appended claims.

1. A viewing apparatus that comprises: a switchable pane electrically alterable between an unclear optical state and a clear optical state; and a power supply circuit connected to the switchable pane and arranged to draw power from a battery to alter the optical state of the switchable pane.

2. The viewing apparatus of claim 1 comprising: a primary unit in which at least one of the power supply circuit and the switchable pane is housed; and
a portable module accommodating the battery from which the power supply circuit is arranged to draw power, wherein the apparatus is arranged for releasable electrical connection between the primary unit and the portable module so that the optical state of the switchable pane is user alterable by placing the portable module into electrical connection with the primary unit and by withdrawing the portable module from electrical connection with the primary unit.

3. The viewing apparatus of claim 2 comprising electrical contacts which are externally accessible on the primary unit for electrical connection between the primary unit and the portable module.

4. The viewing apparatus of claim 2 wherein the power supply circuit is arranged to supply power to the switchable pane when the portable module is in electrical connection with the primary unit and to supply no power to the switchable pane when the portable module is not in electrical connection with the primary unit.

5. The viewing apparatus of claim 2 wherein the power supply circuit is arranged to maintain the switchable pane in its unclear optical state unless the portable module is in electrical connection with the primary unit and to maintain the switchable pane in its clear optical state until the portable module is withdrawn from electrical connection with the primary unit.

6. The viewing apparatus of claim 2 comprising an access controller arranged to receive authentication data and to selectively allow or prevent the supply of power to the switchable pane according to the data received.

7. The viewing apparatus of claim 6 wherein at least one of the primary unit and the portable module comprises a register from which data is readable by the access controller.

8. The viewing apparatus of claim 6 wherein at least one of the primary unit and the portable module comprises a code generator from which a code is receivable by the access controller.

9. The viewing apparatus of claim 2 arranged to log usage or attempted usage of the primary unit.

10. The viewing apparatus of claim 9 wherein at least one of the primary unit and the portable module comprises a data connection and is configured to provide logged usage data to a computer.

11. The viewing apparatus of claim 6 wherein at least one of the primary unit and the portable module comprises a data connection and is configured to receive authentication data from a computer.

12. The viewing apparatus of claim 10 wherein the portable module comprises a data connection and wherein the viewing apparatus further comprises a docking station arranged to receive the portable module and to convey data between the portable module and a computer.

13. The viewing apparatus of claim 6 comprising a remote management system operable by a user to manage the authentication data to selectively allow or prevent operation of the primary unit by the portable module.

14. The viewing apparatus of claim 13 comprising a plurality of the primary units, wherein the management system is user configurable to select which of the primary units are operable by the portable module.

15. The viewing apparatus of claim 13 comprising a plurality of the portable modules, wherein the management system is user configurable to select by which of the portable modules the, or each, primary unit is operable.

16. The viewing apparatus claim 2 wherein the, or each, primary unit comprises a door or part of a door.

17. The viewing apparatus of claim 1 wherein the power supply circuit comprises a switched-mode power supply arranged to supply an AC voltage to the switchable pane.

18. The viewing apparatus of claim 17 wherein the power supply comprises two DC-DC converters.

19. The viewing apparatus of claim 18 wherein the power supply comprises two capacitors, each connected to receive an output voltage of a respective DC-DC converter, so that the two DC-DC converters are each operable to charge a respective capacitor.

20. The viewing apparatus of claim 19 wherein each of the two DC-DC converters is operable to discharge the capacitor which the other of the two DC-DC converters is operable to charge.

21. The viewing apparatus of claim 19 wherein the power supply is arranged to operate the two DC-DC converters in succession to provide an alternating voltage between the two capacitors to drive the switchable pane.

22. The viewing apparatus of claim 19 wherein the power supply comprises a controller arranged to monitor voltages across each of the two capacitors, and to suspend pulse-driven operation of each DC-DC converter when the voltage across the respective capacitor being charged by that DC-DC converter exceeds a predefined threshold.

23. (canceled)
